(19) United States
(12) Patent Application Publication
(10) Pub. No.: US 2017/0110030 A1
(43) Pub. Date: Apr. 20, 2017

(54) Apparatus and Method For Obtaining Visual Oral Airflow Feedback in Speech

(71) Applicant: Jennifer Branchini, Washington, DC (US)

(72) Inventor: Jennifer Branchini, Washington, DC (US)

(21) Appl. No.: 15/297,870

(22) Filed: Oct. 19, 2016

Related U.S. Application Data
(60) Provisional application No. 62/243,462, filed on Oct. 19, 2015.

(51) Int. Cl. G09B 19/04

(52) U.S. Cl. CPC G09B 19/04

(57) ABSTRACT

A visual oral airflow feedback speech apparatus and method for obtaining visual feedback of oral airflow in speech therapy. The visual oral airflow feedback apparatus includes a bridge, a plurality of handles, and a plurality of movable filaments which may be detachable. The apparatus is placed over a user's philtrum where the movable filaments cover a user's mouth. The movable filaments move if air is produced in user's mouth while making various pressure sounds.

### CROSS REFERENCE TO RELATED APPLICATIONS

The present application claims priority to U.S. Provisional Patent Application No. 62,243,462, filed on Oct. 19, 2015.

### FIELD OF THE DISCLOSURE

This disclosure relates generally to speech therapy apparatuses and methods, more particularly, to visual and oral airflow feedback speech apparatuses and methods.

### BACKGROUND

Children and adults are at risk for resonance and articulation impairments due to a history of cleft palate and/or velopharyngeal insufficiency (VPI). As a result of their structural/oral impairments, these children and adults have developed compensatory behaviors (e.g., glottal stops, pharyngeal fricatives) as well as unwanted nasal air emissions. These errors in articulation creates nasal sounding and distorted speech productions that ultimately leave the child or adult unintelligible.

Speech therapists use various apparatuses to assist with their treatment of cleft palate and VPI patients. Many of these apparatuses from simple to complex tools primarily serve to show the patient when nasal air emissions occur. Devices such as an oral nasal listener and nasometer/palatometer mask that are aimed to assist with oral/nasal airflow distinction tend to provide unintentional airflow feedback coming out of a user's mouth when the airflow feedback is actually coming out of the nose. Some of these devices such as a nasometer require a mask to be placed around a user's head. Other apparatuses are invasive including palatometers which are inserted inside the mouth; oral nasal listeners that require a patient to wear earplugs; and See-Scapes devices which are inserted inside a user's nose. For many patients, particularly children, wearing masks that cover entire faces or inserting tubes inside noses may be frightening and/or uncomfortable. Additionally, many of these apparatuses use auditory feedback or technical readings instead of providing clear visual feedback that is understandable to a child/adult and easy for them to use when they are practicing their speech at home.

Current speech therapy apparatuses for cleft palate and VPI patients that assist with oral/nasal airflow distinction are invasive and complex for children's use. In addition, these apparatuses fail to provide clear and accurate, visual oral airflow feedback to the patient. In light of this, there is a need in the art for a non-invasive apparatus that provides clear, visual feedback of oral airflow.

### BRIEF SUMMARY OF THE DISCLOSURE

The following presents a simplified summary of the disclosure in order to provide a basic understanding of some aspects of the invention. This summary is not an extensive overview of every embodiment disclosed herein. It is intended to neither identify key or critical elements of the various embodiments nor delineate the scope of the disclosure. Its sole purpose is to present some concepts of the disclosure, in accordance with the various embodiments disclosed herein, in a simplified form as a prelude to the more detailed description that is presented later.

In one aspect, the present disclosure provides an apparatus and method that enables visual feedback of oral airflow for cleft palate and/or velopharyngeal insufficiency patients who struggle with generating and understanding oral airflow when producing high pressure sounds (e, g, p, b, k, g, t, d).

In another aspect, the present disclosure provides an apparatus and method that is non-invasive and child friendly allowing children to practice and visualize oral airflow in their speech.

In another aspect, the present disclosure provides an apparatus and method that does not allow for unintentional visual feedback of nasal airflow.

In yet another aspect, the present disclosure provides an apparatus and method to teach patients with apraxic speech that sometimes develop inappropriate error patterns that include glottal stops or nasal airflow emissions.

The following description and the annexed drawings set forth certain illustrative aspects of the embodiments of the disclosure. These aspects are indicative, however, of but a few of the various ways in which the principles of the disclosure may be employed and the various embodiments are intended to include all such aspects and their equivalents. Other advantages and novel features will become apparent from the following description when considered in conjunction with the drawings.

### BRIEF DESCRIPTION OF THE FIGURES

FIG. 1 illustrates a front view of an embodiment of a visual oral airflow feedback speech apparatus in accordance with the disclosure.

FIG. 2 illustrates a perspective view of an embodiment of a visual oral airflow feedback speech apparatus in accordance with the disclosure.

FIG. 3 illustrates a front view of an embodiment of a visual oral airflow feedback speech apparatus in accordance with the disclosure.

FIG. 4 illustrates a front view of an embodiment of a visual oral airflow feedback speech apparatus in accordance with the disclosure.

FIG. 5 illustrates a user with an embodiment of the visual oral airflow feedback speech apparatus in accordance with the disclosure.

FIG. 6 illustrates a user with an embodiment of the visual oral airflow feedback speech apparatus in accordance with the disclosure.

FIG. 7 illustrates a user of the apparatus of FIGS. 1-2 by a user.

FIG. 8 illustrates a user of the apparatus of FIGS. 1-2 by a user.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustration of these embodiments are purely illustrative in nature and are in no way intended to limit the scope of the disclosure in any manner. It should also be understood that the drawings are not necessarily to scale and in certain instances details may have been omitted, which are not necessary for an understanding of the embodiments, such as details of fabrication and assembly. In the accompanying drawings, like numerals represent like components.

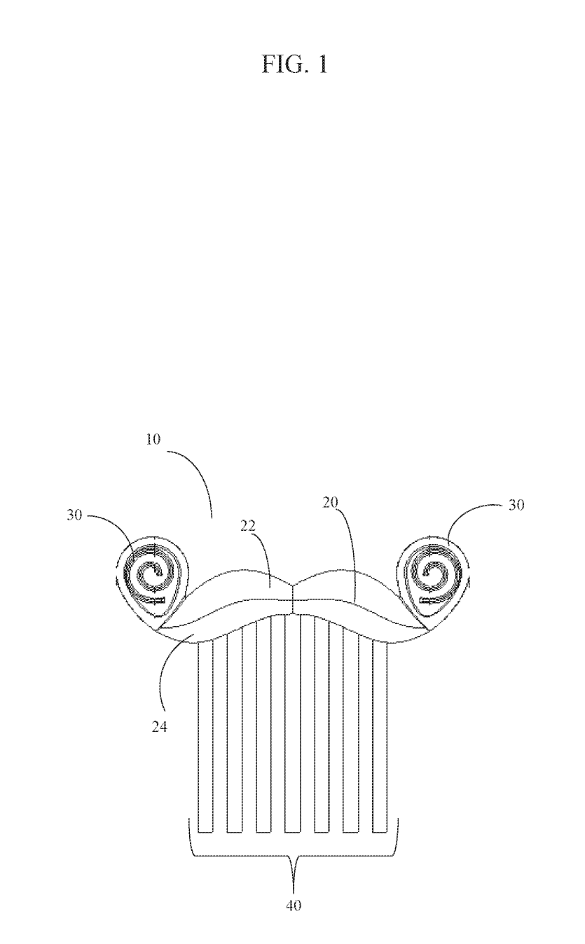

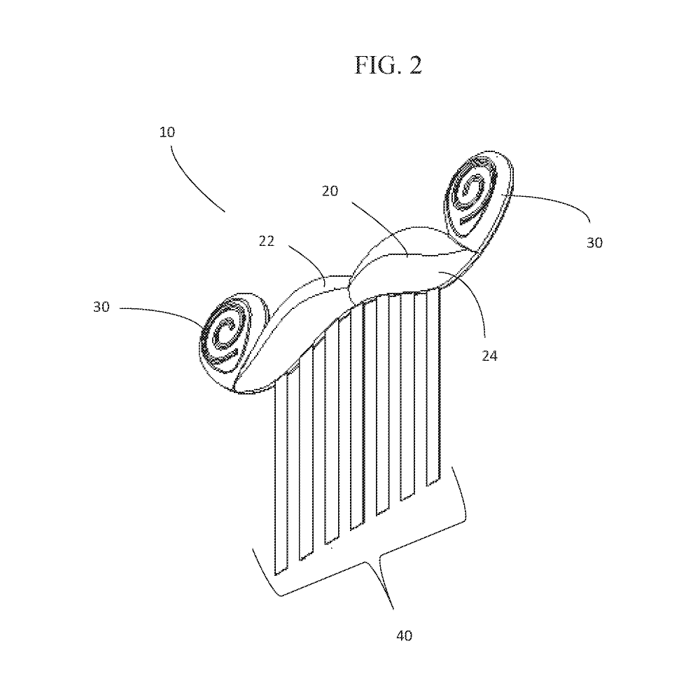

With reference to FIGS. 1 and 2, a visual oral airflow feedback speech apparatus 10 is provided for obtaining visual feedback of oral airflow from a user. The oral airflow apparatus may be composed of a bridge 20, a plurality of handles 30, and a plurality of movable filaments 40. The bridge 20 may comprise of an upper portion 22 and a lower portion 24. The bridge 20 may be placed over a user's philtrum, which is the vertical groove between the base of a user's nose and the border of a user's upper lip, wherein the upper portion of the bridge 22 may be situated below the user's nose and the lower portion of the bridge 24 above the user's lip. The bridge 20 may be made out of plastic, metal, ceramic, leather, nylon, or wood. The length of the bridge 20 may range from three inches to thirteen inches.

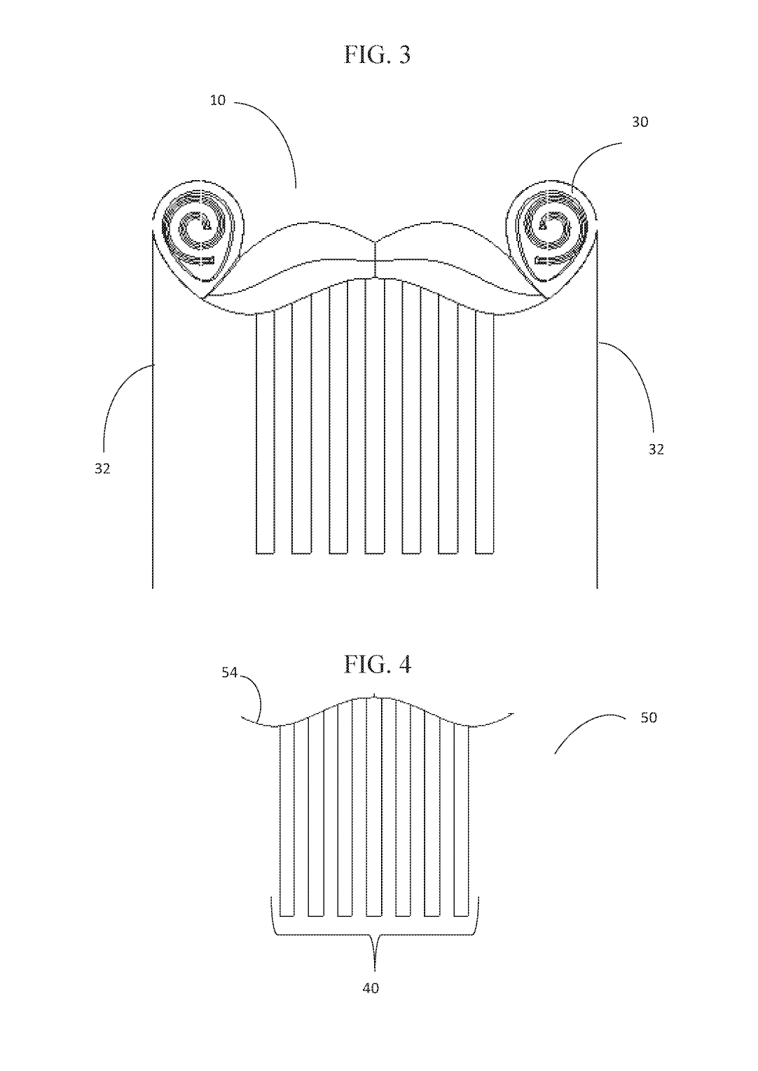

In one embodiment, the handles 30 may extend from the bridge 20 as illustrated in FIGS. 1 and 2. The handles 30 may be placed at opposing ends of the bridge 20 allowing a user to hold the handles 30 with either hand. In another embodiment as illustrated in FIG. 3, the handles 30 may include a plurality of extension handles 32 that allow a user to hold the oral airflow apparatus 10 from a lower position. The extension handles 32 may be attached to the handles 30 and extend down as illustrated in FIG. 3. In other embodiments, the extension handles 32 may extend horizontally or vertically from the handles 30. The handles 30 and extension handles 32 may allow a user to keep the oral airflow apparatus steady for clearer oral airflow feedback. The bridge 20 and handles 30 may be formed into the shape of a moustache. The handles 30 may be made out of plastic, metal, ceramic, leather, nylon, or wood.

The plurality of movable filaments 40 may be made out of plastic, nylon, feathers, rubber, cloth, cotton, or wood. The filaments 40 may be attached to the bridge 20. In one embodiment, the filaments 40 may be attached to the lower portion of the bridge 24 and extend down away from the bridge. The filaments 40 cover the user's mouth. The filaments 40 move if the user produces oral airflow out of the mouth. If the user produces nasal airflow, the filaments 40 do not move. The filaments 40 may be visible to the user so the user can see the filaments 40 move if he/she produces oral airflow. The length of the plurality of movable filaments 40 may range from one inch to ten inches. The width of each movable filament of the plurality of movable filaments 40 may range from one millimeter to nine inches.

In another embodiment, the visual oral airflow feedback apparatus may include a detachable plurality of movable filaments 50. As illustrated in FIG. 4, the detachable plurality of movable filaments 50 may be comprised of a plurality of movable filaments 40 attached to a filament bridge 54. The filament bridge may attach and detach itself to the lower portion of the bridge 24. The filament bridge 54 may attach and detach to the lower portion of the bridge 24 with adhesives, fasteners, or hooks. The detachable plurality of movable filaments 50 may allow a user to replace the detachable plurality of movable filaments 50 if the movable filaments 40 become worn down or torn off from the filament bridge 54. In addition, the detachable movable filaments 50 may allow a user to use the movable filaments on multiple visual oral airflow feedback apparatuses 10.

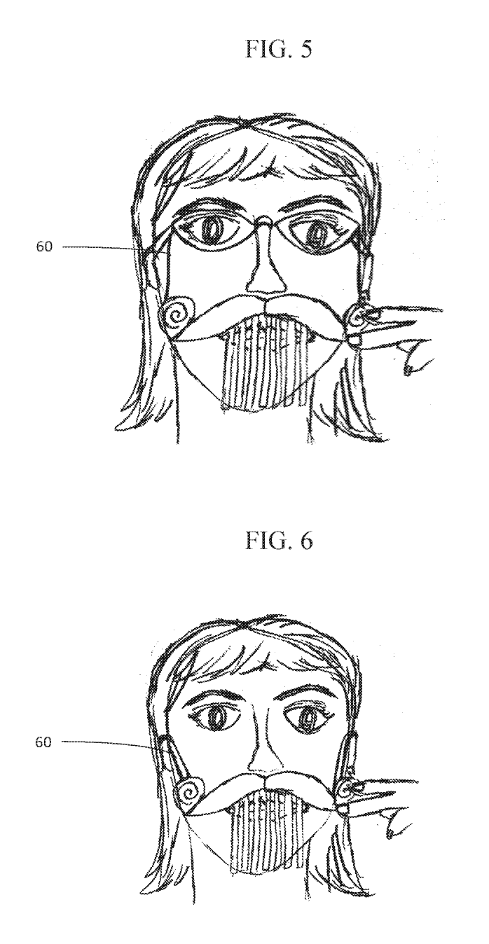

In another embodiment, the oral airflow apparatus 10 may also feature a plurality of securing mechanisms 60 that may attach the oral airflow apparatus 10 to a pair of glasses as illustrated in FIG. 5 . In another embodiment, the securing mechanisms 60 may also attach to the user's ears as illustrated in FIG. 6. The securing mechanisms 60 may attach to the plurality of handles 30 or extend from the handles 30 and may use a hook to attach to a pair of eyeglasses or a user's ears.

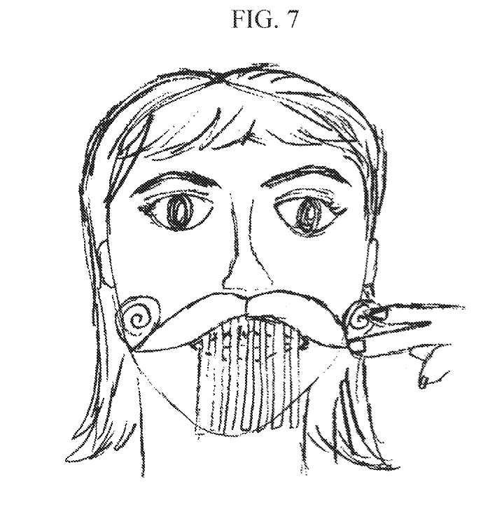

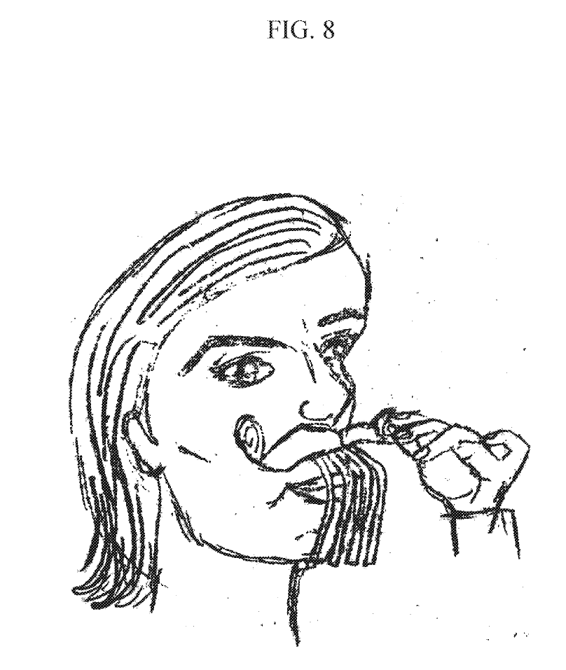

A method for using the visual oral airflow feedback speech apparatus 10 to obtain visual feedback of oral airflow for speech therapy is illustrated in FIGS. 7 and 8. The movable filaments 40 may provide a visual feedback to a user who struggles with generating or understanding oral airflow when producing high pressure sounds (e.g. p, b, t, d, k, g). A user may place the oral airflow apparatus 10 over the user's mouth wherein the upper portion of the bridge 22 is positioned below the user's nose and the lower portion of the bridge 24 is positioned above the user's upper lip. The movable filaments 40 may be attached to the lower portion of the bridge 24 wherein the filaments 40 may cover the user's open or closed mouth. The user may secure the placement of the oral airflow apparatus 10 using the handles 30. When a user produces sound from his/her mouth and air escapes out of the mouth, the movable filaments 40 move. However, when the user produces sound from his/her mouth and air escapes out of his/her nose, the movable filaments 40 do not move. This allows a user an accurate visual feedback when a user is making sounds correctly as he/she can see the filaments 40 move whether directly or in front of a mirror. A user may practice making high pressure sounds (e.g. p, b, t, d, k, g) on his/her own enabling the user to understand oral airflow.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims.

What is claimed is:

1. A visual oral airflow feedback speech apparatus comprising:
a bridge;
a plurality of handles;
a plurality of movable filaments.

2. The visual oral airflow feedback speech apparatus of claim 1, wherein the bridge comprises of an upper portion and a lower portion.

3. The visual oral airflow feedback speech apparatus of claim 1, wherein the plurality of handles may extend from the bridge.

4. The visual oral airflow feedback speech apparatus of claim 1, wherein the plurality of movable filaments are attached to the lower portion of the bridge and extend away from the bridge.

5. The visual oral airflow feedback speech apparatus of claim 1, wherein a plurality of extension handles are attached to the handles.

6. The visual oral airflow feedback speech apparatus of claim 1, wherein a plurality of securing mechanisms are attached to the handles.

7. A visual oral airflow feedback speech apparatus comprising:
a bridge;
a plurality of handles;
a detachable plurality of movable filaments wherein the detachable plurality of movable filaments comprises of a filament bridge and a plurality of movable filaments.

8. The visual oral airflow feedback speech apparatus of claim 6, wherein the bridge comprises of an upper portion and a lower portion.

9. The visual oral airflow feedback speech apparatus of claim 6, wherein the plurality of handles may extend from the bridge.

10. The visual oral airflow feedback speech apparatus of claim 6, wherein the filament bridge of the detachable plurality of movable filaments is attached to the lower portion of the bridge.

11. The visual oral airflow feedback speech apparatus of claim 6, wherein a plurality of extension handles are attached to the handles.

12. The visual oral airflow feedback speech apparatus of claim 6, wherein a plurality of securing mechanisms are attached to the handles.

13. A method for obtaining visual feedback of oral airflow for speech therapy, the method comprising:
providing a visual oral airflow feedback speech apparatus, wherein the visual oral airflow feedback apparatus comprises a bridge, a plurality of handles, a plurality of movable filaments;
placing the bridge of the visual airflow feedback speech apparatus over a user's philtrum, wherein an upper portion of the bride sits below a user's nose and a lower portion of the bridge sits above a user's upper lip, and the movable filaments attached to the lower portion of the bridge cover a user's mouth;
securing the visual oral airflow feedback speech apparatus's placement over the user's philtrum by holding the plurality of handles;
producing sounds from a user's mouth, wherein the movable filaments move if air escapes from the user's mouth and the movable filaments do not move if air escapes from a user's nose.

14. The method of claim 13, wherein the visual oral airflow feedback speech apparatus is secured by holding a plurality of extension handles that are attached to the handles.

15. The method of claim 13, wherein the visual oral airflow feedback speech apparatus is secured by a plurality of securing mechanisms that are attached to the handles.
